(19) United States
(12) Patent Application Publication
(10) Pub. No.: US 2012/0181714 A1
(43) Pub. Date: Jul. 19, 2012

(54) METHOD FOR MANUFACTURING MASTER PLATE FOR OPTICAL DISC

(75) Inventor: Chun-Cheng Chang, Nantou County (TW)

(73) Assignee: RITEK CORPORATION, HSINCHU (TW)

(21) Appl. No.: 13/006,430

(22) Filed: Jan. 14, 2011

(51) Int. Cl. B29D 11/00; B82Y 20/00

(52) U.S. Cl. 264/2.5; 977/904

(57) ABSTRACT

Disclosed herein is a method for manufacturing a master plate of an optical disc. The method comprises the step of: (a) forming an inorganic resist layer on a substrate; (b) forming an organic photoresist layer on and in contact with the inorganic resist layer; (c) irradiating both the organic photoresist layer and the inorganic resist layer with a laser beam to form a first exposed region of the inorganic resist layer and a second exposed region of the organic photoresist layer; (d) removing the inorganic resist layer of the first exposed region and the organic photoresist layer of the second exposed region; (e) removing the patterned organic photoresist layer from the patterned inorganic resist layer; (f) conformally forming a release layer to cover the patterned inorganic resist layer; (g) plating a metal layer on the release layer; and (h) separating the metal layer and the release layer.

### BACKGROUND

1. Field of Invention

The present invention relates to a method for manufacturing a master plate of optical discs.

2. Description of Related Art

By rapid progresses of 3C products and technologies, semiconductors and information recording media require a smaller structure to improve the operation speed and/or the recording density. Taking optical disc storage as an example, conventional read-only DVDs (DVD-ROMs) have a spiral pit string with a pit length of 0.4 μm and a track pitch of 0.74 μm, but the Blue-ray Disc Recordable/Re-writable (BD-R/Re) requires a pit length of 0.17 μm and a track pitch of 0.32 μm. Moreover, Blue-ray Disc Recordable/Re-writable (BD-R/Re) requires not only a track pitch of 0.32 μm, but also a track depth of only 20 nm.

One probable approach to achieve the high precision pattern is by using inorganic resist material. Inorganic resist material refers to a material performs a phase transition while being irradiated, and therefore may be patterned by photolithography. Inorganic resists also provide a clear pattern at the boundary between exposed and unexposed areas compared to organic resists.

However, the inorganic resists have a problem in that it requires a certain thickness to passes the capability of the photolithography. Particularly, if the thickness is less than about 70 nm, it is difficult to obtain a uniform and precise pattern by using typical blue laser, and therefore is difficult to be applied in the manufacturing process of BD-Re.

One solution to this issue is by using a short-wavelength laser with a wavelength of 197 nm. Unfortunately, the exposure system of the short-wavelength laser is extremely expensive because the optical elements must be made of specific materials, and thus rendering this approach cost in-effective.

In view of the above, there exists in the art a new method that would resolve the above mentioned problem.

### SUMMARY

A method for manufacturing a master plate of optical discs is provided. The method comprises the following process. An inorganic resist layer is formed on a substrate. The inorganic resist layer is capable of performing a phase transition while being irradiated by a laser beam. An organic photoresist layer is formed on the inorganic resist layer. And then, both the organic photoresist layer and the inorganic resist layer are irradiated with the laser beam so as to form a first exposed region of the inorganic resist layer and a second exposed region of the organic photoresist layer. The first exposed region of the inorganic resist layer performs the phase transition while being irradiated. Subsequently, the inorganic resist layer of the first exposed region and the organic photoresist layer of the second exposed region are removed, and thus forming a patterned inorganic resist layer and a patterned organic photoresist layer. The patterned organic photoresist layer is then removed from the patterned inorganic resist layer. A release layer is conformally formed to cover the patterned inorganic resist layer on the substrate. A metal layer is plated on the release layer, and then the metal layer is separated from the release layer, so as to get the master plate.

According to one embodiment of the present disclosure, release layer may be made of a polymeric material or an inorganic material such as silicon oxide. In some examples, the release layer comprises a polymeric material selected from the group consisting of phenol-formaldehyde resin, arcryic resin, nitrocellulose, per-chloroethlyene resin, amino resin, polyester, polyurethane resin and epoxy resin.

In one embodiment, the release layer may be formed by coating a layer of polymeric solution on the substrate having the patterned inorganic resist layer, and drying the polymeric solution layer to form the release layer. In one example, the polymeric solution has a solid content of less than 1%. The thickness of the release layer may be less than about 5 nm.

According to one embodiment of the present disclosure, the inorganic resist layer has a thickness of less than 75 nm.

According to another embodiment of the present disclosure, the substrate may comprise a light absorption layer disposed thereon, and the inorganic resist layer is formed on and in contact with the light absorption layer. The light absorption layer may comprise at least one material selected from the group consisting of Si, Ge, GaAs, Bi, Ga, In, Sn, Sb, Te, BiTe, BiIn, GaSb, GaP, InP, InSb, InTe, C, SiC, V₂O₅, Cr₂O₃, Mn₃O₄, Fe₂O₃, Co₃O₄, CuO, AlN, GaN, GeSbTe, InSbTe, BiSbTe, GaSbTe and AgInSbTe. In some examples, the light absorption layer has a thickness of about 10 nm to about 50 nm.

In one embodiment, the inorganic resist layer comprises an inorganic resist material that converts into a crystal phase from an amorphous phase while being irradiated.

In one embodiment, the inorganic resist layer comprises an incomplete oxide of a phase-change material, wherein the incomplete oxide has a general formula of A₍₁₋ₓ₎Oₓ, wherein A represents the phase-change material, and x is a number of about 0.05 to about 0.65. In one example, the phase-change material comprises Ge—Sb—Te, Ge—Sb—Sn, or In—Ge—Sb—Te alloy. For instance, the inorganic resist layer may comprise a material having a formula of GeₓSb_{y}Sn_{z}O_{(1-x-y-z)}, wherein x is a number of about 0.1 to about 0.3, y is a number of about 0.2 to about 0.5, and z is a number of about 0.2 to about 0.6, with a proviso of (1-x-y-z) greater than 0.05.

In another embodiment, the inorganic resist comprises an incompletely oxidized transition metal alloy having an oxygen content lower than the stoichiometric oxygen content of the completely oxidized transition metal alloy, wherein the transition metal is selected from the group consisting of Ti, V, Cr, Mn, Fe, Nb, Cu, Ni, Co, Mo, Ta, W, Zr, Ru, and Ag.

In still another embodiment, the inorganic resist layer comprises tellurium oxide having a formula of TeOₓ, wherein x is a number of about 0.3 to about 1.7.

In some embodiments, the inorganic resist layer comprises an incompletely oxidized metal, wherein the metal is an element of 14^{th} group or 15^{th} group, and the oxygen content in the incompletely oxidized metal is in the range of 75% to 95% of the stoichiometrical oxygen content of the completely oxidized metal.

According to the embodiments of the present disclosure, the substrate may comprise a glass substrate, a silicon substrate, a single crystal alumina (Al₂O₃) substrate, or a quartz substrate.

According to the embodiments of the present disclosure, the organic photoresist layer comprises a novolac-type photoresist or a chemically amplified photoresist. In one example, the organic photoresist layer has a thickness of about 20 nm to about 60 nm.

According to the embodiments of the present disclosure, the laser beam has a wavelength of about 250 nm to about 500 nm.

According to the embodiments of the present disclosure, the inorganic resist layer of the first exposed region and the organic photoresist layer of the second exposed region are removed by applying an alkali solution.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow chart of a nano-fabrication method according to one embodiment of the present disclosure; and

FIG. 2A to FIG. 2H are cross-sectional views schematically illustrating process steps described in FIG. 1.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The present disclosure provides a method for manufacturing a master plate of an optical disc. The nano-fabrication method comprises the step of: (a) forming an inorganic resist layer on a substrate; (b) forming an organic photoresist layer on and in contact with the inorganic resist layer; (c) irradiating both the organic photoresist layer and the inorganic resist layer with a laser beam to form a first exposed region of the inorganic resist layer and a second exposed region of the organic photoresist layer, such that the first exposed region of the inorganic resist layer performs a phase transition, wherein the first exposed region overlaps the second exposed region; (d) removing the inorganic resist layer of the first exposed region and the organic photoresist layer of the second exposed region to form a patterned inorganic resist layer and a patterned organic photoresist layer; (e) removing the patterned organic photoresist layer from the patterned inorganic resist layer; (f) conformally forming a release layer to cover the patterned inorganic resist layer; (g) plating a metal layer on the release layer; and (h) separating the metal layer and the release layer, so as to get the master plate.

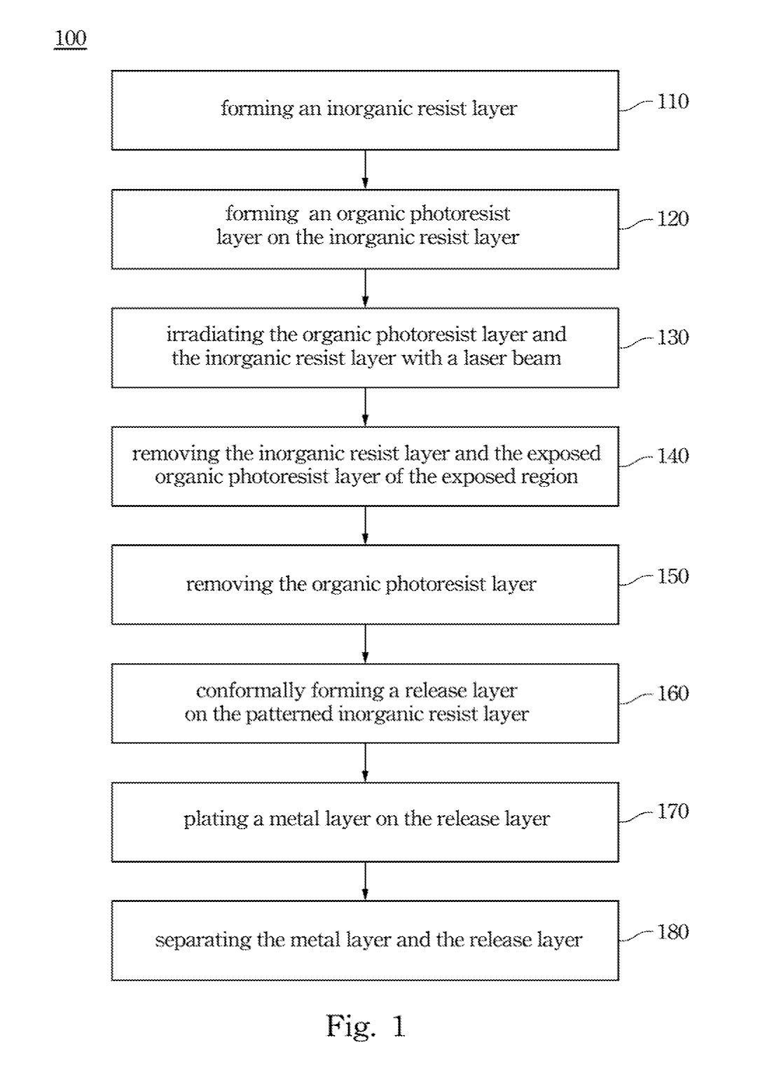

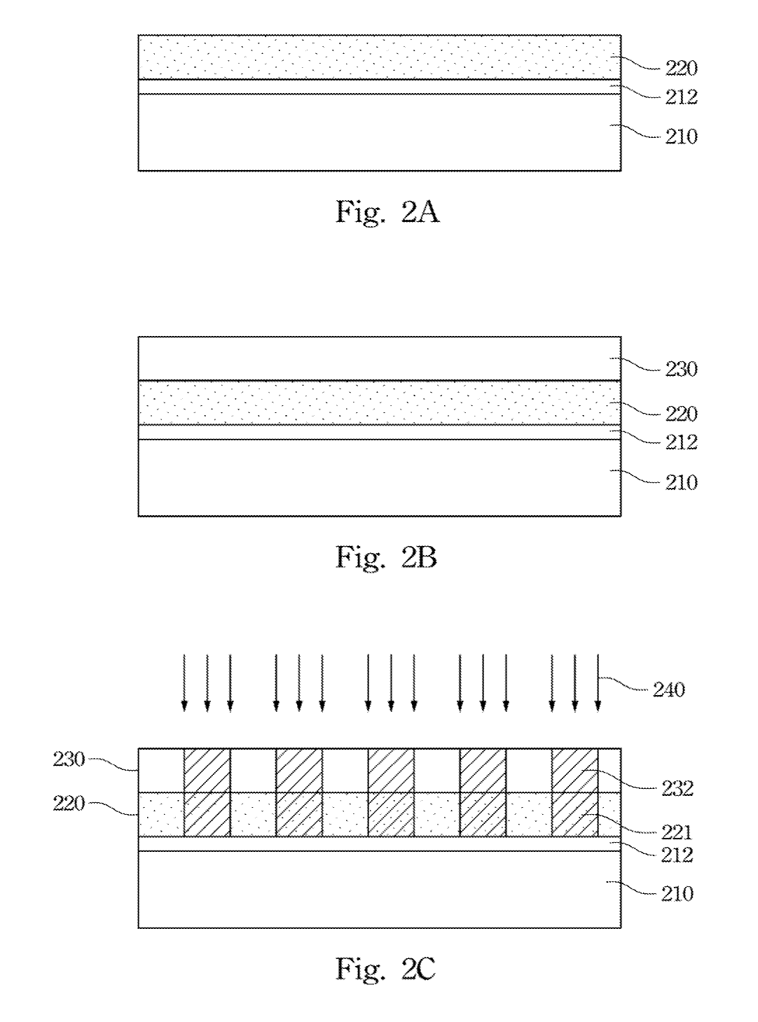

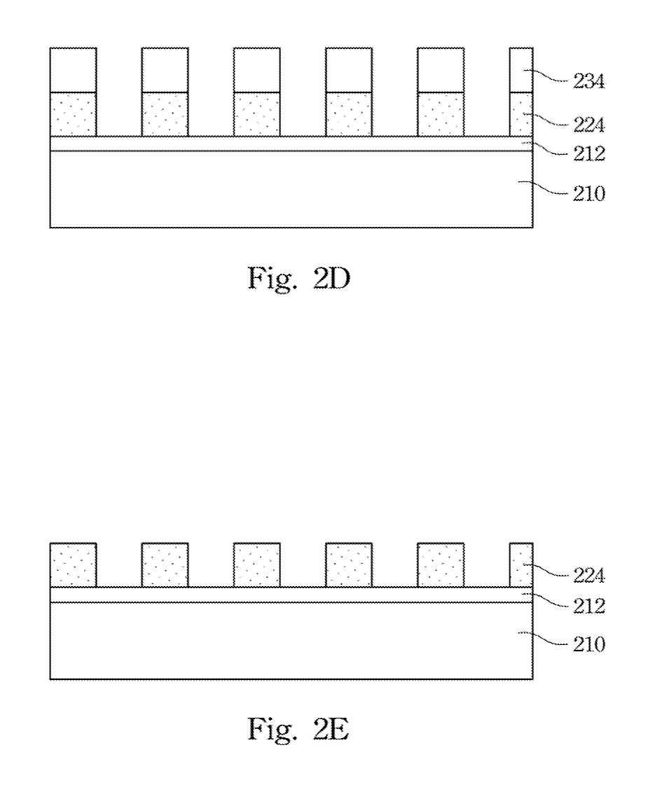

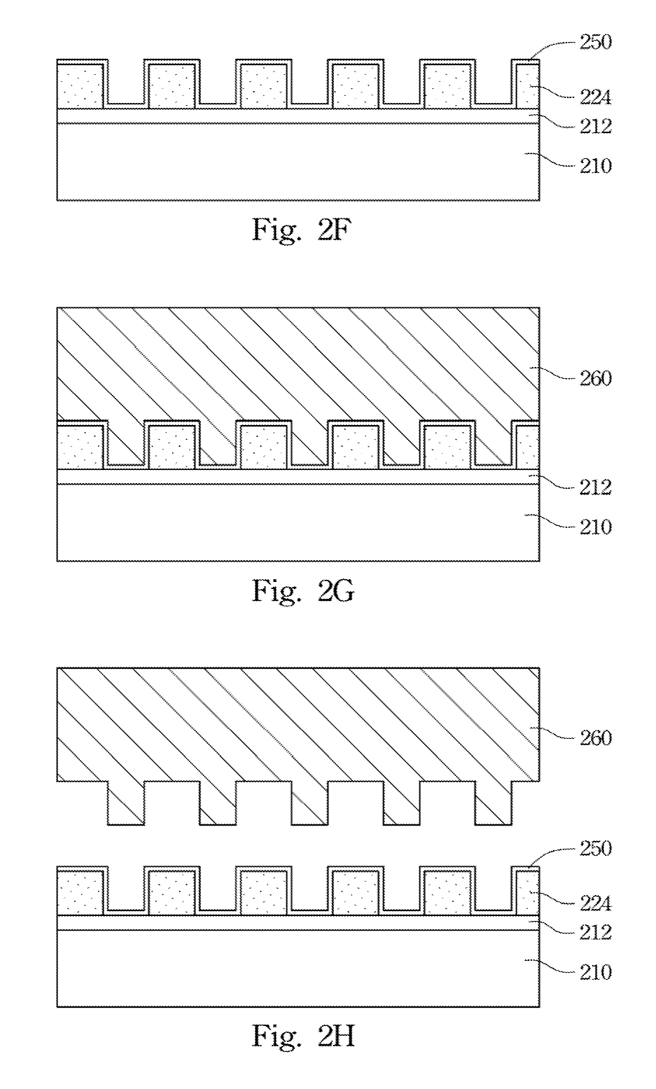

FIG. 1 is a flow chart of a nano-fabrication method 100 according to one embodiment of the present disclosure. FIG. 2A to FIG. 2H are cross-sectional views schematically illustrating process steps described in FIG. 1.

In step 110, an inorganic resist layer 220 is formed on a substrate 210, as depicted in FIG. 2A. The inorganic resist layer is capable of performing a phase transition while being irradiated by a laser beam or being heated. For example, the inorganic resist layer may be converted into a crystal phase from an amorphous phase while being irradiated by a laser beam. In one embodiment, the thickness of the inorganic resist layer 220 may be about 20 nm to about 150 nm, specifically less than 75 nm, more specifically about 20 nm to about 50 nm.

In one embodiment, the inorganic resist layer 220 may comprise an incomplete oxide of a phase-change material. The incomplete oxide has a general formula of A₍₁₋ₓ₎Oₓ, in which A represents the phase-change material, and x is a number of about 0.05 to about 0.65. Specifically, the phase-change material may be a Ge—Sb—Te alloy, a Ge—Sb—Sn alloy, or an In—Ge—Sb—Te alloy. In one example, the inorganic resist layer may comprise a material having a formula of GeₓSb_{y}Sn_{z}O_{(1-x-y-z)}, wherein x is a number of about 0.1 to about 0.3, y is a number of about 0.2 to about 0.5, and z is a number of about 0.2 to about 0.6, with a proviso of (1-x-y-z) greater than about 0.05.

In another embodiment, the inorganic resist layer 220 may comprise an incompletely oxidized transition metal alloy, which has an oxygen content lower than the stoichiometric oxygen content of the completely oxidized transition metal alloy. In this embodiment, the transition metal is selected from the group consisting of Ti, V, Cr, Mn, Fe, Nb, Cu, Ni, Co, Mo, Ta, W, Zr, Ru, and Ag.

In still another embodiment, the inorganic resist layer 220 may comprise tellurium oxide having a formula of TeOₓ, wherein x is a number of about 0.3 to about 1.7.

In some embodiments, the inorganic resist layer 220 may comprise an incompletely oxidized metal. The metal in the incompletely oxidized metal is an element of 14^{th} group or 15^{th} group. The oxygen content in the incompletely oxidized metal is in the range of 75% to 95% of the stoichiometrical oxygen content of the completely oxidized metal.

The material of the substrate 210 is non-limited, so long as it has a sufficient heat-resistant to endure the conditions of the following processes. For example, the substrate 210 may be a glass substrate, silicon substrate, single crystal alumina (Al₂O₃) substrate, or quartz substrate.

In one embodiment, the substrate 210 comprises a light absorption layer 212 disposed thereon, and the inorganic resist layer 220 is formed on and in contact with the light absorption layer 212. The light absorption layer may convert light into heat, and therefore may facilitate the phase transition of the inorganic resist layer. In examples, the material of the light absorption layer may be Si, Ge, GaAs, Bi, Ga, In, Sn, Sb, Te, BiTe, BiIn, GaSb, GaP, InP, InSb, InTe, C, SiC, V₂O₅, Cr₂O₃, Mn₃O₄, Fe₂O₃, Co₃O₄, CuO, AlN, GaN, GeSbTe, InSbTe, BiSbTe, GaSbTe, AgInSbTe, or a combination thereof. In this embodiment, the thickness of the light absorption layer may be in the range of about 10 nm to about 50 nm, specifically about 20 nm. In some examples, when the thickness of the light absorption layer 212 is greater than a certain value, for example about 50 nm, the resolution of the inorganic resist layer decreases. On the other hand, when the thickness of the light absorption layer 212 is less than a certain value, for example 10 nm, it may not provide the function to facilitate the phase transition of the inorganic resist layer.

In step 120, an organic photoresist layer 230 is formed on the inorganic resist layer 220, as depicted in FIG. 2B. The photoresist layer 230 is in contact with the inorganic resist layer 220. The organic photoresist layer 230 may be a positive type photoresist. In one example, the organic photoresist layer 230 may be a novolac-type photoresist or a chemically amplified photoresist. In some embodiments, the thickness of the organic photoresist layer 230 is about 20 nm to about 60 nm, specifically about 30 nm to about 50 nm. In some examples, when the thickness of the organic photoresist layer 230 is greater than a certain value, for example about 60 nm, it would shield the inorganic resist layer 220 form the laser beam, and is unfavorable to the following process. In contrast, when the thickness of the organic photoresist layer 230 is less than a certain value, for example about 10 nm, it may not provide the function that it should possess.

In step 130, both the organic photoresist layer 230 and the inorganic resist layer 220 are irradiated by a laser beam 240, as depicted in FIG. 2C. The laser beam 240 may penetrate both the organic photoresist layer 230 and the inorganic resist layer 220, and thus forming a first exposed region 221 of the inorganic resist layer 220 and a second exposed region 232 of the organic photoresist layer 230. Since the first and second exposed regions 221, 232 are irradiated by the same laser beam, the first exposed region 221 is overlapped by the second exposed region 232. In one embodiment, the wavelength of the laser beam 240 is about 250 nm to about 500 nm, specifically about 380 nm to about 450 nm.

The first exposed region 221 of the inorganic resist layer 220 performs a phase transition due to the irradiation of the laser beam 240. Therefore, the first exposed region 221 has a different phase from the unexposed region of the inorganic resist layer 220. Particularly, the first exposed region 221 has a crystal phase whereas the unexposed region of the inorganic resist layer 220 has an amorphous phase. The first exposed region 221 of the inorganic resist layer 220 becomes soluble to certain chemicals such as alkali solution.

In the case where the organic photoresist layer 230 is a positive type photoresist, the second exposed region 232 of the organic photoresist layer 230 becomes soluble to the photoresist developer such as alkali solution, which is known in the art.

In step 140, both the inorganic resist layer 220 of the first exposed region 221 and the organic photoresist layer 230 of the second exposed region 232 are removed, and thus forming a patterned organic photoresist layer 234 and a patterned inorganic resist layer 224 on the substrate 210, as depicted in FIG. 2D. In this step, the removal of the material in the first and second exposed regions 221, 232 may be accomplished by applying an alkali solution such as potassium hydroxide (KOH) solution and sodium hydroxide (NaOH) solution.

In step 150, the patterned organic photoresist layer 234 are removed from the patterned inorganic resist layer 224, as depicted in FIG. 2E. In this step, the patterned organic photoresist layer 234 may be removed by applying a photoresist stripper solution to peel off the photoresist. Alternatively, it may be removed by applying a solvent that may dissolve the unexposed organic photoresist layer 234. For example, solvents such as acetone may be employed to dissolve the remained organic photoresist layer 234. In one example, the patterned inorganic resist layer 224 remained in the substrate 210 has a width of about 170 nm and a thickness of about 20 nm.

In step 160, a release layer 250 is conformally formed to cover the patterned inorganic resist layer 224, as depicted in FIG. 2F. In one embodiment, the release layer 250 may comprise a polymeric material such as phenol-formaldehyde resin, arcryic resin, nitrocellulose, per-chloroethlyene resin, amino resin, polyester, polyurethane resin and epoxy resin. The polymeric release layer 250 may be formed by coating a polymeric solution on the substrate 210 having the patterned inorganic resist layer 224 thereon, so that a polymeric solution layer is formed and covers the patterned organic photoresist layer 224. And then, the polymeric solution layer is dried, and thus forming the polymeric release layer 250. In one example, the polymeric solution has a solid content of less than 1%. The thickness of the release layer 250 may be less than about 5 nm, specifically about 1 nm to about 3 nm. In some examples, while the thickness of the release layer 250 is greater than about 5 nm, for example, it is difficult to conformally cover the patterned inorganic resist layer 224.

In another embodiment, the release layer 250 may comprise an inorganic material such silicon oxide, alumina oxide and diamond-like carbon (DLC). The inorganic release layer 250 may be formed by sputtering in a short period, for example, about 5 seconds to about 30 seconds.

In step 170, a metal layer 260 plated on the release layer 250, as depicted in FIG. 2G. The metal layer 260 may be formed by any known method such electro plating, physical vapor deposition or other methods. In one example, the metal layer 260 is made of nickel, and is formed by electroplating. The metal layer 260 may have a complementary profile to the patterned inorganic resist layer 224, and will become the master plate for optical discs.

In step 180, the metal layer 260 is separated from the release layer 250, and the separated metal layer 260 becomes the master plate for optical discs. The metal layer 260 may be separated by manual methods or by machinery.

### EXAMPLES

The following Examples are provided to illustrate certain aspects of the present invention and to aid those of skill in the art in practicing this invention. These Examples are in no way to be considered to limit the scope of the invention in any manner.

### Example 1

### Fabricating the Master Plate by Using a Polymeric Release Layer

A 20 nm silicon layer, as a light absorption layer, was deposited on a glass substrate by sputtering in an argon (Ar) atmosphere at a pressure of 0.5 Pa. During the silicon sputtering, a DC source of 350 W was used and the Ar flow rate was 30 sccm. Next, an inorganic resist layer about 20 nm in thickness was deposited on the silicon layer, by sputtering, using a Ge_{13.5}Sb₄₀Sb_{46.5} target in an argon-oxygen mixed atmosphere (Ar/O₂=5/1) at a pressure of 0.8 Pa. Subsequently, a novolac-type photoresist was coated on the inorganic resist layer by spin costing, and followed by a baking process at a temperature of 130° C. for 900 seconds. An organic photoresist layer about 25 nm in thickness was formed on the inorganic resist layer.

The substrate coated with the organic photoresist layer was exposed to a laser beam with a wavelength of 405 nm. The exposure was carried out with an irradiation power of 3.2 mW. The laser beam penetrated both the organic photoresist layer and the inorganic resist layer.

After the exposure, a developing process was performed by KOH solution with a concentration of 0.05 M. The developing time period in this example was 40 sec. Both the exposed organic photoresist layer and the exposed inorganic resist layer were dissolved in the KOH solution, whereas the unexposed portions were remained on the substrate. Therefore, both of the organic photoresist layer and the inorganic resist layer were simultaneously patterned. The unexposed organic photoresist was removed by using acetone, and thus a patterned inorganic resist layer was obtained.

A polymeric solution containing 0.8 wt % of phenol-formaldehyde resin was coated on the substrate having the patterned inorganic resist layer by spinning coating, and followed by a drying process at a temperature of 130° C. for 900 seconds. After the drying process, a layer of phenol-formaldehyde resin as the release layer was formed on the substrate and conformally covering the patterned inorganic resist layer.

A 300 μm layer of nickel was formed on the polymeric release layer of the substrate by electroplating. Subsequently, the nickel plate was separated from the polymeric release layer of the substrate. The separated nickel plate was sufficiently washed with acetone, and then was dried to get the master plate capable of providing a track depth of about 20 nm.

### Example 2

### Fabricating the Master Plate by Using a Silicon Dioxide as a Release Layer

In this example, the master plate was fabricated by the same method described in EXAMPLE 1, except that the phenol-formaldehyde resin layer was replaced by a layer of silicon oxide, as the release layer. The silicon oxide sputtering was carried out for a shout period of about 2 second, and thus the thickness of the silicon oxide layer is about 1 nm.

### Comparative Example

### Fabricating the Master Plate without Using a Release Layer

In this comparative example, the master plate was fabricated by the same method described in EXAMPLE 1, except that the formation of the release layer was omitted. In particular, the nickel layer was formed on and in contact with the patterned inorganic resist layer. In this comparative example, when the nickel layer was separated from the patterned inorganic resist layer of the substrate, portions of the patterned inorganic resist layer were peeling off the substrate and embedded in the nickel plate. The pattern inorganic layer had a thickness of only about 20 nm, and thus the adhesion between the inorganic resist layer and the substrate was weak. As a result, the nickel plate fabricated by the procedure of this comparative example may not be successfully used a master plate for optical discs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for manufacturing a master plate of an optical disc, comprising:
(a) forming an inorganic resist layer on a substrate;
(b) forming an organic photoresist layer on and in contact with the inorganic resist layer;
(c) irradiating both the organic photoresist layer and the inorganic resist layer with a laser beam to form a first exposed region of the inorganic resist layer and a second exposed region of the organic photoresist layer, such that the first exposed region of the inorganic resist layer performs a phase transition, wherein the first exposed region overlaps the second exposed region;
(d) removing the first exposed region of the inorganic resist layer and the second exposed region of the organic photoresist layer to form a patterned inorganic resist layer and a patterned organic photoresist layer;
(e) removing the patterned organic photoresist layer from the patterned inorganic resist layer;
(f) conformally forming a release layer to cover the patterned inorganic resist layer;
(g) plating a metal layer on the release layer; and
(h) separating the metal layer from the release layer, so as to get metal layer as the master plate.

2. The nano-fabrication method of claim 1, wherein the inorganic resist layer of the step (a) has a thickness of less than 75 nm.

3. The nano-fabrication method of claim 1, wherein the substrate of the step (a) comprises a light absorption layer disposed thereon, and the inorganic resist layer is formed on and in contact with the light absorption layer, wherein the light absorption layer comprises at least one material selected from the group consisting of Si, Ge, GaAs, Bi, Ga, In, Sn, Sb, Te, BiTe, BiIn, GaSb, GaP, InP, InSb, InTe, C, SiC, V₂O₅, Cr₂O₃, Mn₃O₄, Fe₂O₃, Co₃O₄, CuO, AlN, GaN, GeSbTe, InSbTe, BiSbTe, GaSbTe and AgInSbTe.

4. The nano-fabrication method of claim 1, wherein the inorganic resist layer of the step (a) comprises an inorganic resist material that converts into a crystal phase from an amorphous phase while being irradiated.

5. The nano-fabrication method of claim 1, wherein the inorganic resist layer of the step (a) comprises an incomplete oxide of a phase-change material, wherein the incomplete oxide has a general formula of A₍₁₋ₓ₎Oₓ, wherein A represents the phase-change material, and x is a number of about 0.05 to about 0.65.

6. The nano-fabrication method of claim 5, wherein the phase-change material comprises Ge—Sb—Te, Ge—Sb—Sn, or In—Ge—Sb—Te alloy.

7. The nano-fabrication method of claim 1, wherein the inorganic resist layer of the step (a) comprises a material having a formula of GeₓSb_{y}Sn_{z}O_{(1-x-y-z)}, wherein x is a number of about 0.1 to about 0.3, y is a number of about 0.2 to about 0.5, and z is a number of about 0.2 to about 0.6, with a proviso of (1-x-y-z) greater than 0.05.

8. The nano-fabrication method of claim 1, wherein the inorganic resist layer of the step (a) comprises an incompletely oxidized transition metal alloy having an oxygen content lower than the stoichiometric oxygen content of the completely oxidized transition metal alloy, wherein the transition metal is selected from the group consisting of Ti, V, Cr, Mn, Fe, Nb, Cu, Ni, Co, Mo, Ta, W, Zr, Ru, and Ag.

9. The nano-fabrication method of claim 1, wherein the inorganic resist layer of the step (a) comprises tellurium oxide having a formula of TeOₓ, wherein x is a number of about 0.3 to about 1.7.

10. The nano-fabrication method of claim 1, wherein the inorganic resist layer of the step (a) comprises an incompletely oxidized metal, wherein the metal is an element of 14^{th} group or 15^{th} group, and the oxygen content in the incompletely oxidized metal is in the range of 75% to 95% of the stoichiometrical oxygen content of the completely oxidized metal.

11. The nano-fabrication method of claim 1, wherein the substrate of the step (a) comprises a glass substrate, a silicon substrate, a single crystal alumina (Al₂O₃) substrate or a quartz substrate.

12. The nano-fabrication method of claim 1, wherein the organic photoresist layer of the step (b) comprises a novolac-type photoresist or a chemically amplified photoresist.

13. The nano-fabrication method of claim 1, wherein the organic photoresist layer of the step (b) has a thickness of about 20 nm to about 60 nm.

14. The nano-fabrication method of claim 1, wherein the laser beam of the step (c) has a wavelength of about 250 nm to about 500 nm.

15. The nano-fabrication method of claim 1, wherein the step (d) comprises applying an alkali solution to remove the first exposed region of the inorganic resist layer.

16. The nano-fabrication method of claim 1, wherein the release layer of the step (f) comprises silicon oxide.

17. The nano-fabrication method of claim 1, wherein the release layer of the step (f) comprises a polymeric material.

18. The nano-fabrication method of claim 17, wherein the polymeric material comprises at least one polymer selected from the group consisting of phenol-formaldehyde resin, arcryic resin, nitrocellulose, per-chloroethlyene resin, amino resin, polyester, polyurethane resin and epoxy resin.

19. The nano-fabrication method of claim 1, wherein the step (f) comprises;
coating a layer of polymeric solution on the substrate having the patterned inorganic resist layer, wherein the polymeric solution has a solid content of less than 1%; and
drying the polymeric solution layer to form the release layer.

20. The nano-fabrication method of claim 1, wherein the release layer has a thickness of less than 5 nm.
